(19) United States
(12) Patent Application Publication
(10) Pub. No.: US 2013/0104047 A1
(43) Pub. Date: Apr. 25, 2013

(54) SYSTEM FOR DELIVERY OF RANDOM NOVEL CONTENT

(71) Applicants: Dana E. Laursen, Corvallis, OR (US); Thomas M. Carrico, Corvallis, OR (US)

(72) Inventors: Dana E. Laursen, Corvallis, OR (US); Thomas M. Carrico, Corvallis, OR (US)

(21) Appl. No.: 13/276,533

(22) Filed: Oct. 19, 2011

(51) Int. Cl. G06F 3/01; G06F 15/16

(52) U.S. Cl. 715/738

(57) ABSTRACT

A system for delivery of random novel content is disclosed. The system includes identification of the random novel content from source content imported from a content provider and in response to a selection of a selectable icon visually presented on a web-enabled device. The system further includes presentation of the identified random novel content to an output device via the web-enabled device.

### BACKGROUND

The present disclosure relates generally to a system for delivery of random novel content.

Content delivery is commonly used with electronic displays and with printers. Previous systems exist for delivering content on a subscription basis. Other systems recommend selections to be chosen by a user. Yet other systems allow a user to navigate through collections and sub-collections of possible selections in order to choose a desired item.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic illustration of an example of a system for delivery of random novel content according to the present disclosure;

FIG. 2 is a schematic illustration of an example of communication between an example of a publishing module, a web-enabled device and an output device according to the present disclosure;

FIG. 3 is a schematic illustration of an example of a selectable icon user interface incorporated into an example of a web-enabled device according to the present disclosure;

FIG. 4 is a schematic illustration of examples of web-enabled devices and output devices according to the present disclosure;

FIG. 5 is a schematic illustration of an example of a web-enabled device and an example of a publishing module in operative communication according to the present disclosure;

FIG. 6 is a schematic illustration of an example of a mobile device and an example of a publishing module in operative communication according to the present disclosure; and

FIG. 7 is a flow diagram depicting an example of a method according to the present disclosure.

### DETAILED DESCRIPTION

The present disclosure includes examples of a system and method that simplify a selection and publication process and delivers random novel content.

Examples of the system and method for delivery of random novel content disclosed herein allow users to receive random novel content in a simple manner, introducing elements of novelty, surprise, and fun. Generally, the system receives a request for random novel content from a web-enabled device. Thereafter, the system executes a process resulting in publication of random novel content to an output device. The system reduces the previously required user interaction of finding and selecting content in a large collection. A single step for selection replaces a complex process of navigation and selection. This may be more convenient to the user because fewer steps are involved. The system also may keep track of previously presented content to minimize occurrence of repeated delivered content. The system may produce an immediate response, delivering the desired subject matter with unpredictable but compelling results. Additionally, the simple interface of the system may, in some instances, minimize screen real estate on devices with small screens.

Examples of various delivery options allow for differing types of results. With truly random selection, the same content may in theory be delivered multiple times. In addition to random selection, examples of the system as disclosed herein allow other selection algorithms that appear random while eliminating or minimizing duplicate selections.

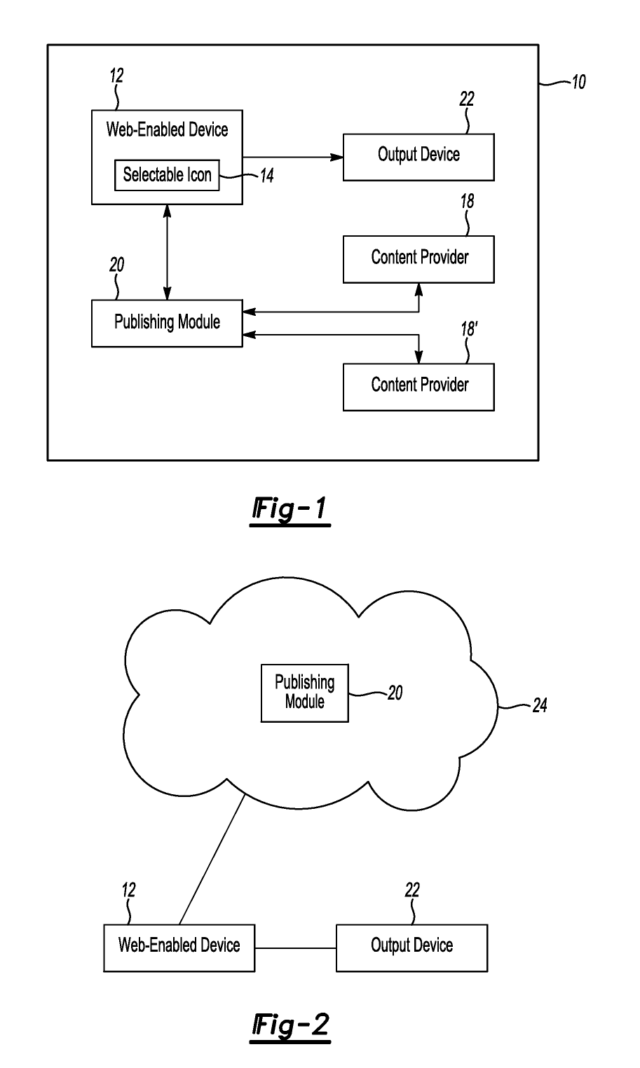

Referring now to FIG. 1, a schematic illustration of an example of a system for delivery of random novel content according to the present disclosure is shown. System 10 includes a web-enabled device 12 to visually present a selectable icon 14 thereon. The system also includes a publishing module 20 that communicates with the web-enabled device 12 and with content providers 18 to import source content. The publishing module 20 receives a request in response to a selection of the web-enabled device icon 14, the publishing module 20 having operatively associated therewith a non-transitory, tangible computer-readable medium having embedded therein instructions executable by a processor 48 (see, e.g., FIG. 5) of the publishing module 20. The publishing module 20 identifies the random novel content from the source content and presents the identified random novel content to the output device 22 via the web-enabled device 12. The system 10 may allow for the random novel content to be presented for a first time to the output device 22. The publishing module 20 may identify imported/received source content previously presented to the output device 22 and select random novel content from the imported/received source content that is identified as having not been previously presented to the output device 22.

The publishing module 20 may perform an algorithmic process that generates a list of the random novel content that may be random, sequential, or preprogramed. For example, the novel selection process may be adapted to facilitate a contest or to deliver rewards such as coupons. The random novel content may be selected from a content menu hierarchy operatively connected to the output device 22. The content menu hierarchy may have multiple levels, and random novel content may be selected from any one of these levels of the content menu. Alternatively, the selection may be done from a predefined portion of a hierarchy. The selection may retrieve a random piece/portion from the source content, or the selection may uniquely identify a particular piece/portion from the source content as the user navigates a content hierarchy.

The publishing module 20 may also, after the random novel content is identified, deliver the identified random novel content to the output device 22 via the web-enabled device 12 on a recurring schedule, at a predetermined time, or by a combination of both of the preceding options. In an example, this allows a user to receive content on demand, or have a subscription service where content is received periodically according to a schedule. The random novel content may include unique content in response to selection criteria. The delivery of the identified random novel content to the output device 22 via the web-enabled device 12 may also be in a sequential manner. In examples, the selection of random novel content may be individually randomized, such that there could be repeat presentations/delivery of content, or the order may be determined by a randomly generated sequence, such that duplicates are eliminated unless the sequence is repeated. Additionally, selection criteria may influence the selection or order. Such selection criteria may include consumer preferences or demographics, for example. Also, the selection or order may be specified by an editor, in a planned selection.

Referring now to FIG. 2, an example of the publishing module 20 is shown operatively disposed within a cloud 24. An example of the web-enabled device 12 may communicate over the cloud 24 as local device module interaction with the publishing module 20. The publishing module 20 may be a server module in the cloud. It is to be understood that the “cloud” is a computer network accessible over the Internet and/or web that is dynamically scalable with virtualized resources, such as printing resources. In an example, the cloud may or may not be physically distributed. A user interoperating with the cloud is not required to have knowledge or expertise in the infrastructure of the cloud that relies on the Internet to satisfy his/her computing needs. The cloud provides the services of the publishing module 20 that are accessible from a web browser, while software and data are stored on servers in the cloud. Additionally, in an example, the output device 22 may be embedded in the web-enabled device 12, or the output device 22 may be remote from, but connected to the web-enabled device 12.

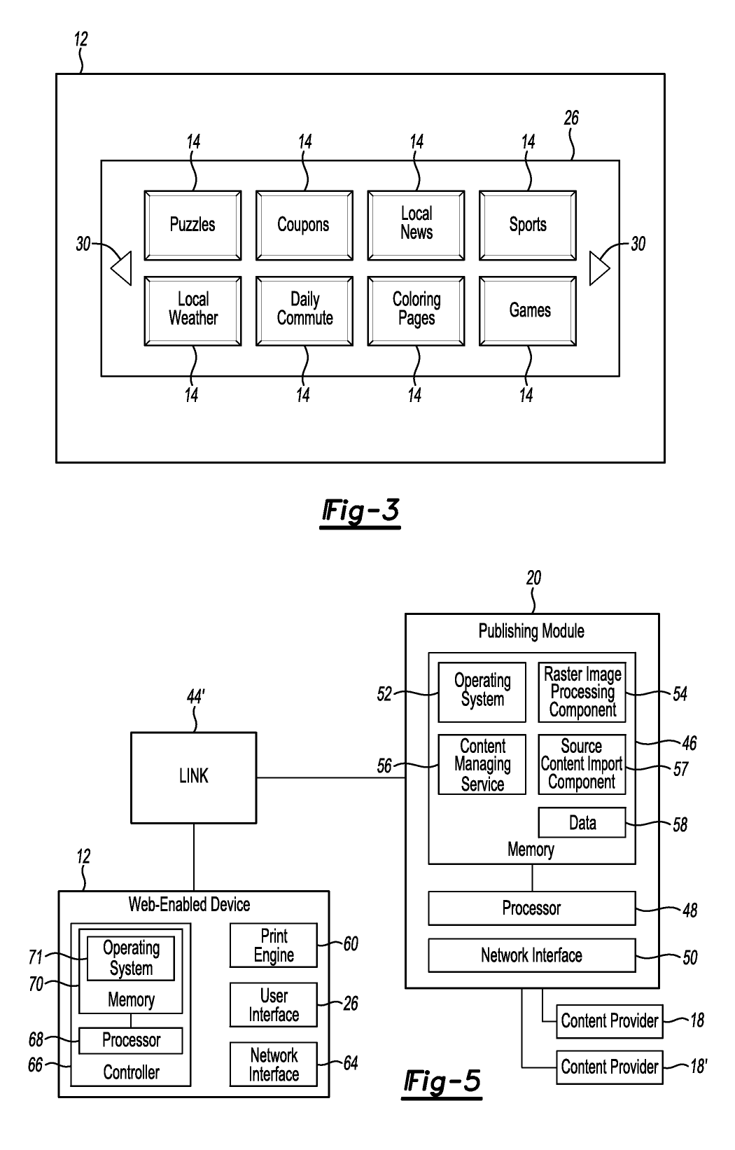

FIG. 3 illustrates an example screen shot of a selectable icon user interface 26. In this example, the device 12 presents a user with eight icons 14 with which the user may choose to interact to initiate a request for delivery of random novel content to an output device 22 via the web-enabled device 12. The icons 14 include various choices, e.g., “Puzzles”, “Coupons”, “Local News”, “Sports”, “Local Weather”, “Daily Commute”, “Coloring Pages” and “Games” as descriptive word references for categories of novel content from which the user may choose. In an example, the user interface 26 is a touchscreen display, and the user may interact with an icon 14 by touching a portion of the touchscreen that displays the icon 14. A user may also prompt the user interface 26 to display additional content choices by virtue of the user interacting with “more content” icons or navigational symbols 30 that may be part of the display 12. For example, the icons may refer to content identifiers by use of descriptive words (e.g., “puzzles,” “coupons,” and “local sports”). The icons also may refer to content identifiers by use of images, such as logos, avatars, or other visual depictions. In other examples, a user may interact with the user interface 26 in a manner other than touching a touchscreen, for example by actuating buttons, or by uttering audible instructions that are received and interpreted at the user interface 26.

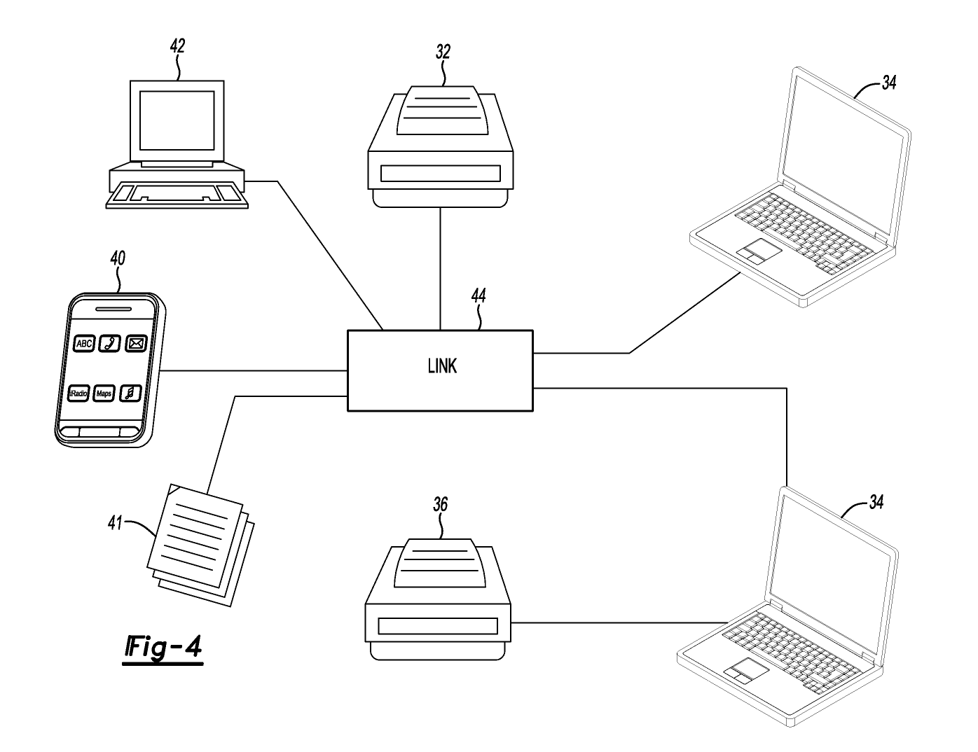

FIG. 4 depicts several examples of web-enabled devices 12 and output devices 22. As briefly described above, the output device 22 may be embedded in the web-enabled device 12 or may be remote from, but connected to the web-enabled device 12. The web-enabled device 12 and the output device 22 may be individually chosen from: a web-enabled printer 32, a personal computer 34 with printer 36, a personal computer 34 without a dedicated printer 36, a mobile device with an integrated display 40, electronic paper 41, and another device 42. Example mobile devices 40 include smart phones, personal digital assistants (PDAs), netbooks, tablets, digital media players, and the like. As used herein, a web-enabled printer 32 includes a printer that can be connected to the Internet or an intranet, so as to be capable of receiving content, sending and receiving messages, and/or running applications via the Internet or an intranet. In an example, a web-enabled printer 32 may operate in a standalone mode without being connected to a host computing device. In such an example, printer 32 may be configured to receive print jobs via the Internet, email or an external memory device. In another example, printer 32 is connected to a host computing device via a cable or wireless or other means in a manner such that printer 32 may receive instructions and print jobs from a host. In another example, printer 32 may connect directly to one or more hosts via the Internet or an intranet. Further, web enabled printer 32 may be a printer that is not itself connected to the Internet or an intranet, but rather is connected to the Internet or the intranet by virtue of being connected, e.g., via a cable or wireless connection, to a host computing device that is connected to the Internet or intranet. Additional variants may also be included, as shown by the example of another device 42 depicted in FIG. 4. Although the other device 42 is shown as a personal computer, it is to be understood that the other device 42 could be any other suitable device capable of implementing examples of the system and method as disclosed herein, including, e.g., mp3 players, any types of audio players, video players, etc.

FIGS. 4, 5, and 6 each refer to a link (44, 44′, and 44″ respectively). In each example, the link represents generally one or more of a cable, wireless, fiber optic, or remote connection via a telecommunication link, an infrared link, a radio frequency link, or any other connectors or systems that provide electronic communication. As shown in the figures, a link may include, at least in part, the Internet, an intranet, or a combination of both. A link may also include intermediate proxies, routers, switches, load balancers, and the like. The paths followed by links 44, 44′, and 44″ between devices, modules, and displays as depicted in FIGS. 4, 5, and 6 represent the logical communication paths between these items, not necessarily the physical paths between the devices.

“Content”, as used herein, refers to information that can be received by and stored at a computer system for possible later presentation/delivery to a user. Examples of visual content include text, graphics and other images capable of being visually displayed and/or printed at a printing device. Examples of visual content may also include video/movie content capable of being displayed on output device 22. Examples of audio content may include music or speech to be processed and delivered to the output device 22. Content may also include instructions designed to be processed by a computing device. Example content formats may include PDF and other page description formats, HTML, RSS feeds and other XML formats, JPEG, TIFF and other image formats, and document formats such as Microsoft® Word, Microsoft Excel®, and Adobe InDesign®.

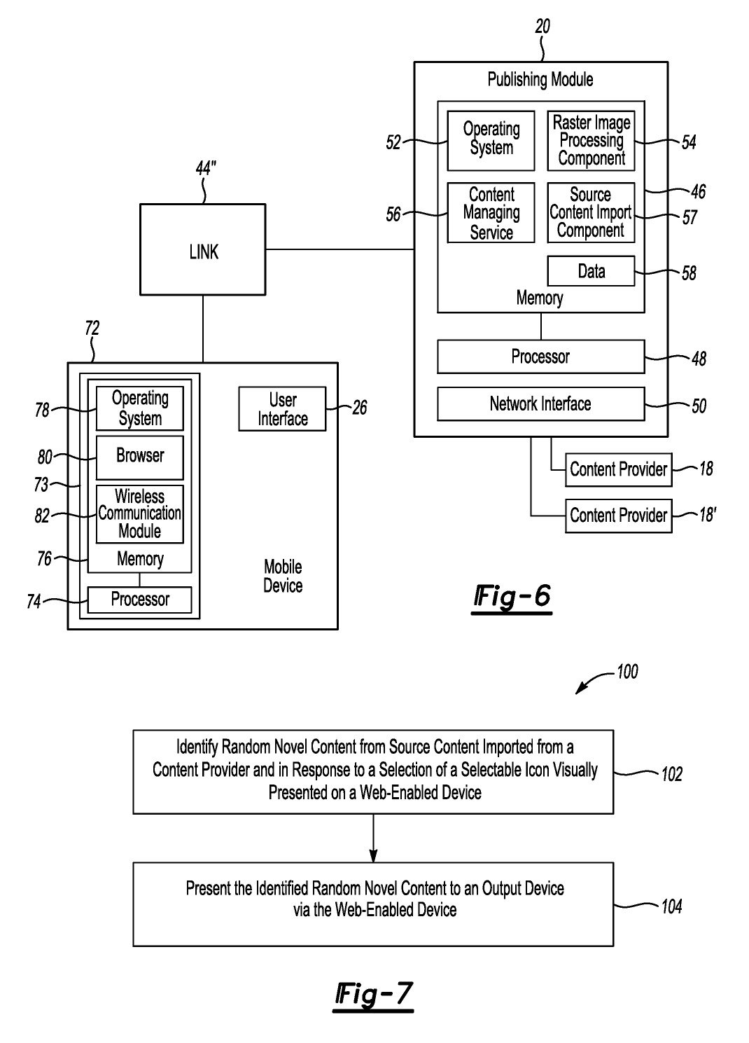

Further, as used herein, “source content” refers to a library, repository, or store of content that can be electronically stored in a memory. In an example, source content is obtained from a computing device that is part of a computing system of a content provider, an example of which may be a web site. One or several content providers may be involved, as shown by the example of content provider 18 and content provider 18′ in FIGS. 5 and 6. In an example, first source content is obtained from a first computing system, and second source content is obtained from a separate second computing system. For example, first source content may be obtained from a first computing device that is a part of a computing system of a news publisher, and second source content may be obtained from a second computing device that is part of a computing system of an entertainment publisher. There is no limit to the number of content providers that may be involved. In certain examples, source content may also include other information, such as audio or video information, that is played directly on the output device 22, or that is capable of being transformed to a printable format and then printed or displayed at output device 22. In an example, audio source content may be obtained by publishing module 20 and then converted to a visual format (e.g., text) at some point prior to printing/displaying.

Referring now to FIG. 5, publishing module 20 represents generally any computing device capable of receiving source content from content providers 18 and 18′, and providing source content to web-enabled device 12. In an example, a publishing module 20 providing source content may include sending or pushing the source content to an output device 22 via the web-enabled device 12. In an example, a publishing module 20 providing source content may include sending the source content to a holding destination where the source content is subsequently retrieved or pulled by web-enabled device 12 for delivery to the output device 22. For example, publishing module 20 may send the source content to a File Transfer Protocol (FTP) site or Really Simple Syndication (RSS) feed, where the source content is subsequently retrieved by web-enabled device 12 for delivery to output device 22. In an example, publishing module 20 provides updated source content at regular, e.g., daily, weekly, or monthly, intervals.

Publishing module 20 is additionally capable of receiving requests for random novel content from, and causing random novel content to be obtained by web-enabled device 12. Publishing module 20 may include a memory 46, a processor 48, and a network interface 50. In a given implementation, processor 48 may represent multiple processors, and the memory 46 may represent multiple memories. In an example, the publishing module 20 may include a number of software components that are stored in a computer-readable medium (e.g., memory 46) and are executable by processor 48. In this respect, the term “executable” includes a program file that is in a form that can be directly (e.g., machine code) or indirectly (e.g., source code that is to be compiled) performed by the processor 48. An executable program may be stored in any portion or component of memory 46.

Memory 46 may include an operating system 52, a raster image processing (RIP) component 54, a content managing service 56, source content import component 57, and data 58. Operating system 52 represents generally any software platform on top of which other programs or applications such as the raster image processing component 52 and the content managing service 56 run. Examples include Linux® and Microsoft Windows®. Raster image processing component 54 represents generally any combination of hardware and software capable of converting digital information about fonts and graphics that describes the intended appearance of the content, and translating that information into an image composed of individual dots that a printer can output. In examples, raster image processing component 54 may be additionally configured to compose page layouts and scaling operations.

Content managing service 56 represents generally any programming, that, when executed, is responsible for obtaining source content from a content provider 18. In an example, obtaining source content from a content provider 18 may include causing the source content to be sent directly or indirectly by a content provider 18 to publishing module 20. In an example, obtaining source content from a content provider 18 may include causing the source content to be retrieved from a holding destination, e.g., an FTP site or RSS feed (where the source content has been sent by content provider 18) and made available for direct or indirect retrieval by the publishing module 20. In an example, obtaining source content from content provider 18 may include obtaining the content via a request, e.g., Application Programming Interface (API) request via Hypertext Transfer Protocol (HTTP), from publishing module 20 to a content provider 18. The content may be obtained from a content provider 18 and stored in memory 46. Content managing service 56 is additionally responsible for receiving a request for delivery, without user intervention, of random novel content to output device 22 via the web-enabled device 12. The random novel content includes at least a portion of the source content that is obtained from the content provider 18. The received request may be a request that is initiated via user interaction with a user interface 26 at the web-enabled device 12.

Content managing service 56 is additionally responsible for establishing a protocol for delivery of the random novel content to output device 22 via the web-enabled device 12. The protocol may be established at least in part on information from the request for delivery and data 58 stored in a memory 46 within the publishing module 20. Content managing service 56 is further responsible for causing formatting of the random novel content, in accordance with the protocol. The formatting of the random novel content may occur via a raster image processing component 54 at publishing module 20. Content managing service 56 is also responsible for causing the random novel content to be obtained by the output device 22 via the web-enabled device 12. In an example, causing content to be obtained by an output device 22 via the web-enabled device 12 may include causing the random novel content to be sent directly or indirectly from publishing module 20 to the output device 22 via the web-enabled device 12.

In an example, causing content to be obtained by output device 22 may include causing the random novel content to be sent by publishing module 20 to a holding destination, e.g., an FTP site or RSS feed, where the content is made available for direct or indirect retrieval by output device 22 via the web-enabled device 12. Indirect retrieval may include retrieval by a host computing device that is web-enabled and connected to the output device 22, which host device in turn sends the content to the output device 22 or allows the output device 22 to retrieve the content from the host device. In an example, causing random novel content to be obtained by output device 22 may include obtaining the content via a request, e.g., API request via HTTP, sent to publishing module 20 by web-enabled device 12. In the example of FIG. 5, the formatting of the random novel content occurs at publishing module 20, and the content is obtained by the output device 22 after the formatting. Source content import component 57 represents generally any hardware and software that supports the pulling or retrieval of information from the source content providers 18, 18′.

Data 58 represents generally a collection of information stored in memory 46. Data 58 may include source content data. Further, data 58 may include information used by content managing service 56 to establish a protocol for delivery of the random novel content. In an example, data 58 may include information as to the model or type of output device 22. In another example, data 58 may include time zone information relevant to the physical location of output device 22.

Network interface 50 represents generally any combination of hardware and programming configured for electronically connecting publishing module 20 to link 44′. In an example, the network interface may include a network interface card, a network adapter, a network interface controller, and or a Local Area Network (LAN) adapter.

Web-enabled device 12 and/or output device 22 may include a computing device capable of obtaining random novel content from publishing module 20, producing visual and/or audio output from the random novel content, and communicating information relating to the obtained random novel content and/or the visual/audio output back to the publishing module 20. In the example of the web-enabled device 12 shown in FIG. 5, the web-enabled device 12 includes a print engine 60, a user interface 26, a network interface 64, and a controller 66. Print engine 60 represents generally any combination of hardware, firmware and software capable of producing visual output from the random novel content obtained from the publishing module 20. In particular, print engine 60 may use imaging material such as ink or toner to form a desired image on a print medium. Additionally, an output medium may include audio-visual displays, such as on-screen graphics or videos (e.g., on computer displays, mobile device displays, etc.). The print engine 60 may also include a raster image processing engine. The raster image processing engine can include all of the capabilities discussed above for the raster image processing component 54.

Network interface 64 may include any combination of hardware, firmware and software to electronically connect web-enabled device 12 to link 44′. Controller 66 may include any combination of elements capable of acting as an embedded computing device to coordinate the operation of print engine 60, user interface 26 and network interface 64. In a given implementation, the controller 66 includes a processor 68 and a memory 70, and the memory 70 may include an operating system 71. Operating system 71 represents generally any software platform on top of which other programs or applications run. The processor 68 may represent multiple processors, and the memory 70 may represent multiple memories.

Now referring to FIG. 6, a mobile device 72 represents generally any computing device capable of sending to another computing device, such as publishing module 20, a request for delivery of random novel content to an output device 22 via the web-enabled device 12. In a given implementation, the mobile device 72 includes a controller 73 with a processor 74 and a memory 76. Controller 73 may include any combination of elements capable of acting as an embedded computing device to coordinate operation of the user interface 26. The processor 74 may represent multiple processors, and the memory 76 may represent multiple memories. Memory 76 may include an operating system 78, a browser 80 and a wireless communication module 82. Operating system 78 represents generally any software platform on top of which other programs or applications such as the browser 80 and the wireless communication module 82 run. Examples include Palm® OS, iPhone® OS, Blackberry® OS, Windows®, Phone 7 and Symbian™ OS. Browser 80 may include any combination of hardware, firmware and software capable of sending network requests for content to other computing devices. Browser 80 is capable of sending a request to publishing module 20 for delivery of content to output device 22 via the web-enabled device 12. Wireless communication module 82 may include any combination of hardware, firmware and software to enable wireless communication between mobile device 72 and other computing devices over a wireless communication network.

It is to be understood that memory 46, 70, 76 may be a computer-readable storage medium including various types of memory modules, including volatile and nonvolatile memory. As an example, the computer-readable storage medium may include Random Access Memory (RAM), Read Only Memory (ROM), and Hard Disk Drive (HDD) memory. It is believed that other types of memory may also be used. In some instances, different types of memory in the computer-readable storage medium may be used for different data storage needs. For example, the processor may boot from ROM, maintain nonvolatile storage in the HDD memory, and execute program code stored in RAM.

It is to be understood that the computer-readable storage medium may be an electronic, magnetic, optical, electromagnetic, infrared, or semiconductor system, apparatus, or device, or any suitable combination thereof. More specific examples of the computer-readable storage medium may include, for example, the following: a portable computer diskette, a hard disk, a RAM, a ROM, an erasable programmable read-only memory (EPROM or Flash memory), a portable compact disc read-only memory (CD-ROM), an optical storage device, a magnetic storage device, or any suitable combination thereof.

Referring now to FIG. 7, an example of a method according to the present disclosure is designated generally at 100. Examples of method 100 may be carried out by instructions executable by one or more processors 48, 68, 74. The instructions are embedded within a non-transitory, tangible computer-readable medium. Method 100 includes identifying random novel content from source content received from publishing module 20 and in response to a selection of a selectable icon 14 visually presented on the web-enabled device 12, as shown at reference number 102. Method 100 further includes presenting the identified random novel content to an output device 22 via the web-enabled device 12, as shown at reference number 104.

Examples of method 100 may further include identifying any received source content that had been previously presented to the output device 22 via the web-enabled device 12, and selecting the random novel content from the received source content that is identified as having not been previously presented to the output device 22 via the web-enabled device 12.

In another example, method 100 may also select a portion of content from the received source content and determine whether the selected portion of content is being presented for a first time to the output device 22 via the web-enabled device 12. The selected portion of content may be presented/delivered as the identified random novel content to the output device 22 via the web-enabled device 12 when it is determined that the selected portion of content is being presented for the first time. Alternately, another portion of content may be selected from the received source content when it is determined that the selected portion of content is not being presented for the first time.

Examples of method 100 may further include performing an algorithmic process that generates a list of the random novel content that is any of random, sequential, or preprogrammed, as mentioned above.

It is to be understood that the terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween).

It is to be understood use of the words “a” and “an” and other singular referents include plural as well, both in the specification and claims.

While several examples have been described in detail, it will be apparent to those skilled in the art that the disclosed examples may be modified. Therefore, the foregoing description is to be considered non-limiting.

What is claimed is:

1. A system for delivery of random novel content, comprising:
a web-enabled device to visually present a selectable icon thereon, the web-enabled device in communication with an output device; and
a publishing module including a source content import component to import content from a content provider, the publishing module in communication with the web-enabled device, the publishing module to receive a request in response to a selection of the web-enabled device icon, the publishing module having operatively associated therewith a non-transitory, tangible computer-readable medium having embedded therein instructions executable by a processor of the publishing module, the instructions to:
identify the random novel content from the source content imported from the content provider; and
present the identified random novel content to the output device.

2. The system as defined in claim 1 wherein the random novel content is to be presented for a first time to the output device.

3. The system as defined in claim 1 wherein the instructions to identify the random novel content further include instructions to:
identify any imported source content that had been previously presented to the output device; and
select the random novel content from the imported source content that is identified as having not been previously presented to the output device.

4. The system as defined in claim 1 wherein the instructions to identify the random novel content include an algorithmic process that generates a list of the random novel content that is any of i) random, ii) sequential, or iii) preprogrammed.

5. The system as defined in claim 1 wherein the random novel content is selected from a content menu hierarchy, the content menu hierarchy being operatively connected to the output device.

6. The system as defined in claim 1 wherein the instructions to present the identified random novel content include instructions, after the random novel content is identified, to deliver the identified random novel content to the output device: i) on a recurring schedule; ii) at a predetermined time; or iii) a combination of i and ii.

7. The system as defined in claim 1 wherein the instructions to present the identified random novel content include instructions to deliver the identified random novel content to the output device in a sequential manner.

8. The system as defined in claim 1 wherein the random novel content includes unique content in response to selection criteria.

9. The system as defined in claim 1 wherein the output device is embedded in the web-enabled device, or is remote from, but connected to the web-enabled device.

10. The system as defined in claim 1 wherein the web-enabled device and the output device can be individually chosen from: web-enabled printers, personal computers with printers, personal computers with separate displays, mobile devices with integrated displays, electronic paper, audio players, and video players.

11. A non-transitory, tangible computer-readable medium having embedded therein instructions executable by a processor, the instructions to:
identify random novel content from source content imported from a content provider and in response to a selection of a selectable icon visually presented on a web-enabled device; and
present the identified random novel content to an output device via the web-enabled device.

12. The non-transitory, tangible computer-readable medium as defined in claim 11 wherein the instructions to identify further include instructions to:
identify any imported source content that had been previously presented to the output device; and
selecting the random novel content from the imported source content that is identified as having not been previously presented to the output device.

13. The non-transitory, tangible computer-readable medium as defined in claim 11 wherein the instructions to identify further include instructions to:
select a portion of content from the imported source content;
determine whether the selected portion of content is being presented for a first time to the output device; and
any of:
i) present the selected portion of content as the identified random novel content to the output device when it is determined that the selected portion of content is being presented for the first time; or
ii) select an other portion of content from the imported source content when it is determined that the selected portion of content is not being presented for the first time.

14. The non-transitory, tangible computer-readable medium as defined in claim 11 wherein the instructions to identify the random novel content include an algorithmic process that generates a list of the random novel content that is any of i) random, ii) sequential, or iii) preprogrammed.
